(19) United States
(12) Patent Application Publication
(10) Pub. No.: US 2011/0091690 A1
(43) Pub. Date: Apr. 21, 2011

(54) COMPOSITE OPTICAL FILM AND DECORATED ARTICLE COMPRISING THE SAME

(75) Inventors: Chun-Hsu Lin, Taichung City (TW); Chih-Yuan Liao, Hsinchu County (TW)

(73) Assignee: SIPIX CHEMICAL INC., Taoyuan County (TW)

(21) Appl. No.: 12/770,730

(22) Filed: Apr. 30, 2010

(30) Foreign Application Priority Data
Oct. 20, 2009 (TW) 98135350
Dec. 30, 2009 (TW) 98145740

(51) Int. Cl. B44C 1/165; B32B 7/06

(52) U.S. Cl. 428/162; 428/161

(57) ABSTRACT

The present invention provides a composite optical film as well as a decorated article comprising the same. The composite optical film comprises a substrate, a releasing layer, an optional durable layer, an ink layer, and an adhesive layer. The first surface of the substrate forms the first roughened configuration with an average roughness Ra of at least 0.5 μm. The releasing layer, whose second surface adheres to the first surface of the substrate, forms the second roughened configuration complementing the corresponding first configuration. Via the second roughened configuration and varying thickness of the releasing layer, the composite optical film generates glossy gradient effects.

### CROSS-REFERENCE TO RELATED APPLICATION

This application claims the priority benefits of Taiwan patent application serial no. 98135350, filed on Oct. 20, 2009, and application serial no. 98145740, filed on Dec. 30, 2009. The entirety of each of the above-mentioned patent applications is hereby incorporated by reference herein and made a part of specification.

### BACKGROUND OF THE INVENTION

1. Technical Field

The present invention relates to a composite optical film and the decorated article comprising the same, and more particularly, to a composite optical film capable of creating glossy gradient effects.

2. Description of Related Art

Consumers have higher expectations for the appearance of electronic products, including cell phone communication products, notebook computers, PDA information products, audio products, digital cameras, home appliances, auto parts, cosmetics packaging products, panels in cars and motorcycles, membrane keyboard switches, heat compress products, and all kinds of plastic leather. Therefore, the current trend in developing consumer electronics and home appliance products has changed from a focus on functional upgrades to one that emphasizes both functional upgrades and appearance. Similarly, the surface decoration technology has migrated to in-mold decoration (IMD) to improve product appearance while avoiding the highly polluting process of traditional spray coating. IMD offers the greatest development potential among current surface decoration technologies. IMD applications are commonly seen, especially in electronic products, such as cell phone keyboards, cell phone cases, and top covers of notebook computers.

As part of the molding process, IMD generally refers to the application of words, pictures, or symbols on molded products. The three types of IMD are in-mold roller (IMR), in-mold label (IML), and curved surface in-mold forming (IMF). IMD incorporates four processes: film printing, hot press molding, stamping and cutting, and injection molding. By replacing traditional spray coating, IMD supports the environmental protection trend. To meet the growing demand for light transmission effects, curved surfaces, and artificial materials, IMD employs a production process that is efficient, environmentally friendly, and cost effective in terms of time and space, to create high quality products that give exquisite and modem effects; complex processing work and losses are reduced, saving costs.

Using IMD, the outermost layer of processed molded plastic parts has a smooth surface that gives them a gloss. However; when users touch the outermost layer, skin oils leave fingerprints on the smooth surface, affecting the overall appearance. Also, traditional IMD processing has difficulty achieving a glossy gradient effect.

To overcome the disadvantages of a traditional low gloss decorative film that cannot have pictures and can have only a single gloss value, prior arts have developed many kinds of low gloss decorative films; light extinction particles are added to the durable layer, and through the light scattering of small particles, a rough surface is formed. However, the light extinction particles precipitate easily, causing an uneven distribution of light extinction particles at the surface that precludes a glossy gradient effect. Light extinction particles are also added to the releasing layer of decorative films; however, the silicones of the releasing layer and the light extinction particles are not compatible, resulting in a separation between inorganic and organic phases at the film surface.

As a result, decorative films require enhanced designs to incorporate pictures and to provide glossy gradients.

### SUMMARY OF THE INVENTION

To overcome the shortcomings of the prior arts mentioned above, the present invention provides a composite optical film. The composite optical film comprises a substrate, a releasing layer, an ink layer, and an adhesive layer. The releasing layer, the ink layer, and the adhesive layer are stacked serially on the substrate. Via applying a plate-type or a roller-type mold having an imprinting configuration on the substrate during imprinting, the first roughened configuration of the first surface is formed. Meanwhile, the varying thickness caused by the first roughened configuration in the area of the substrate is also formed. Based on the varying thickness of the substrate, A second roughened configuration of the releasing layer, corresponding and complementing to the first roughened configuration, is formed. The releasing layer consequently has a varying thickness. Via the second roughened configuration and the varying thickness, the releasing layer enables the lights to shift in different directions; thereby the composite optical film is capable of generating glossy gradient effects, partial glossy and partial foggy effect.

It is the primary object of the present invention to provide a composite optical film that comprises a substrate having a first roughened configuration which is formed by imprinting, hence the composite optical film is able to generate glossy gradient effects, partial glossy and partial foggy effect.

It is another object of the present invention to provides a composite optical film that further comprises a durable layer interposed between the releasing layer and the ink layer. The durable layer has a third roughened configuration and a varying thickness caused by the third roughened configuration. Via the third roughened configuration and the varying thickness, the durable layer not only reduces the surface gloss but also enables the lights to shift in different directions; thereby the composite optical film is capable of generating glossy gradient effects, partial glossy and partial foggy effect.

Additionally, this present invention provides a composite optical film that comprises a substrate, a releasing layer, an ink layer, and an adhesive layer. The releasing layer, the ink layer, and the adhesive layer are stacked serially on the substrate. Via applying a plate-type or a roller-type mold having an imprinting configuration on the releasing layer during imprinting, a roughened configuration on the releasing layer is formed. Meanwhile, the varying thickness caused by the roughened configuration of the releasing layer is also formed. Via the roughened configuration and the varying thickness, the releasing layer enables the lights to shift in different directions. Thereby the composite optical film is capable of generating glossy gradient effects, partial glossy and partial foggy effect.

It is another object of the present invention to provide a composite optical film that comprises a releasing layer having a roughened configuration which is formed by imprinting, hence the composite optical film is able to generate glossy gradient effects, partial glossy and partial foggy effect.

It is another object of the present invention to provide a composite optical film that further comprises a durable layer interposed between the releasing layer and the ink layer. Via applying a plate-type or a roller-type mold having an imprinting configuration to the releasing layer during imprinting, a first roughened configuration on the releasing layer is formed. The durable layer has a second roughened configuration, corresponding and complementing to the first roughened configuration. Via the second roughened configuration and the varying thickness, the durable layer not only reduces the surface gloss but also enables the lights to shift in different directions; thereby the composite optical film is capable of generating glossy gradient effects, partial glossy and partial foggy effect.

Moreover, it's still yet another object of the present invention to provide a decorated article using any one of the abovementioned composite optical films which ares capable of generating glossy gradient effects, partial glossy and partial foggy effect.

### BRIEF DESCRIPTION OF THE DRAWINGS

The invention as well as a preferred mode of use, further objects and advantages thereof, will best be understood by reference to the following detailed description of an illustrative embodiment when read in conjunction with the accompanying drawings, wherein:

FIG. 1A and FIG. 1B are cross-sectional views of a composite optical film according to the first embodiment of the present invention.

FIG. 2A and FIG. 2B are cross-sectional views of a composite optical film according to the second embodiment of the present invention.

FIG. 3 is a cross-sectional view of a composite optical film according to the third embodiment of the present invention.

FIG. 4A and FIG. 4B are cross-sectional views of a composite optical film according to the fourth embodiment of the present invention.

FIG. 5A to FIG. 5D are cross-sectional views of a decorated article according to the fifth embodiment of the present invention.

### DETAILED DESCRIPTION OF THE PREFERRED EMBODIMENT

Some particular embodiments of the invention will be described in detail for purpose of illustration, and one of ordinary skill in the art can easily understand the advantages and efficacy of the present invention through the disclosure of the specification. It is to be understood that alternative embodiments may be possible for the implement and application of the present invention while numerous variations will be possible to the details disclosed in the specification on the strength of diverse concepts and applications without going outside the scope of the invention as disclosed in the claims.

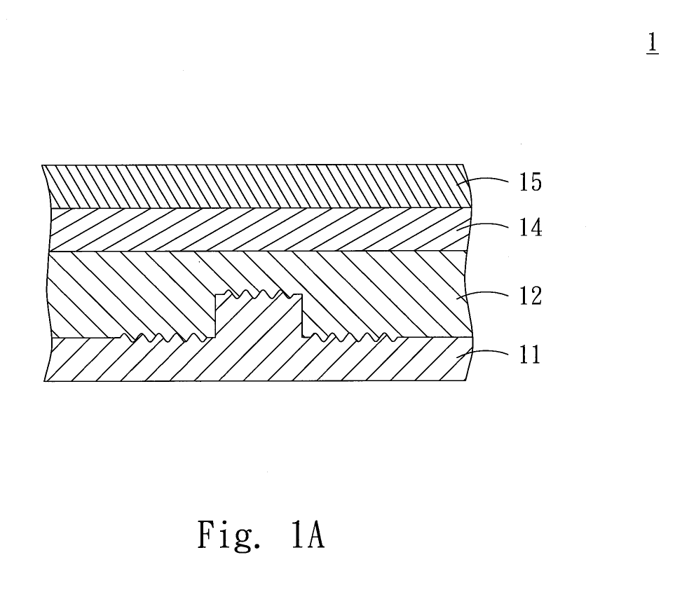

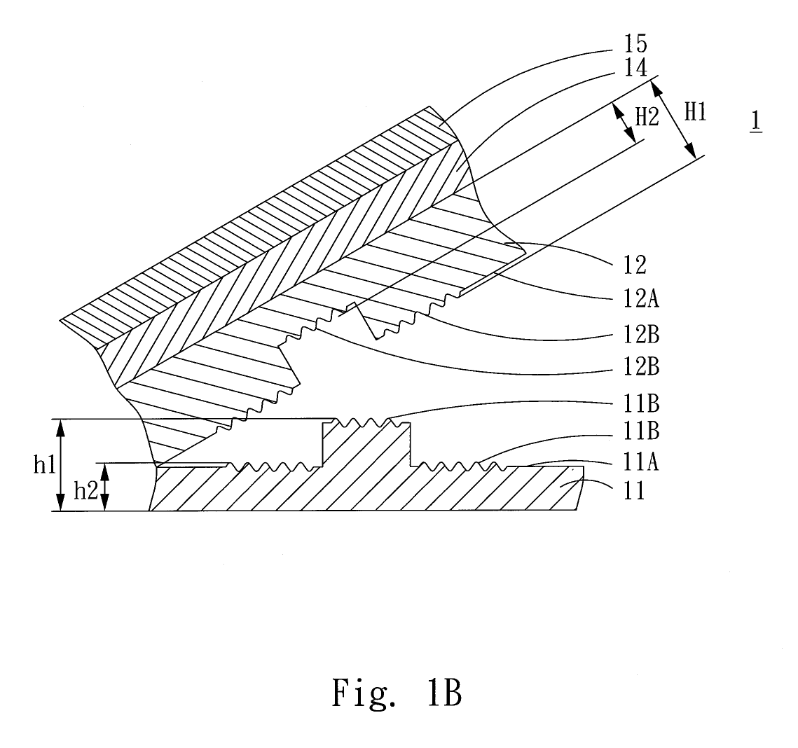

Please refer to FIG. 1A, which shows the first embodiment of the present invention. This composite optical film 1 comprises a substrate 11, a releasing layer 12, an ink layer 14, and an adhesive layer 15. The substrate 11, the releasing layer 12, the ink layer 14, and the adhesive layer 15 are stacked serially. The material from which the substrate 11 is made can be polyethylene terephthalate, polyethylene naphthalate, glycol-polyethylene terephathalate, thermoplastic polyurethane, polyurethane, polypropylene, polycarbonate, amorphous polyethylene terephthalate, polyvinyl chloride, cellulose triacetate, polyamide, styrene-methyl methacrylate copolymer, cyclic olefin copolymer, or a combination of the aforementioned materials.

Please refer to FIG. 1B, which also shows the first embodiment of the present invention. The substrate 11 has a first surface 11A. A first roughened configuration 11B is formed on the first surface 11A by an imprinting method. A mold having an imprinting configuration is applied in the imprinting method, wherein the imprinting configuration has at least two different depths. The mold could be a plate-type mold or a roller-type mode. Via the imprinting method, the imprinting configuration is applied to imprint on the first surface 11A of the substrate 11 to form the first roughened configuration 11B thereon. Accordingly, substrate 11 has a varying thickness where the first roughened configuration 11B being formed. Specifically, the substrate 11 has a thicker first portion h1 and a thinner second portion h2. The imprinting method in this embodiment can be planar imprinting, rolling imprinting, or stamping. The roughness of the first roughened configuration 11B is usually expressed by the arithmetic average of the roughness profile, or Ra. The Ra value of the first roughened configuration 11B may be equal to or more than 0.5 μm. The releasing layer 12 is stacked on the substrate 11. The releasing layer 12 includes a second surface 12A which adheres to the first surface 11A of the substrate 11. The second surface 12A includes a second roughened configuration 12B. The second roughened configuration 12B is complementary to the corresponding first roughened configuration 11B and has a roughness Ra equal to or more than 0.5 μm, because the second surface 12A adheres to the first surface 11A. The thickness of the releasing layer 12 ranges from 1 μm to 10 μm. For describing the features more detailedly, the substrate 11 and releasing layer 12 are imaginarily stripped here. The thicker first portion h1 and the thinner second portion h2 are shown in FIG. 1B. Then, based on the varying thickness and the first roughened configuration 11B of the substrate 11, the releasing layer 12 also possesses varying thickness where the second roughened configuration 12B being formed. Specifically, the releasing layer 12 conformably has a thicker first portion H1 and a thinner second portion H2. In addition, the composite optical film 1 in this embodiment also includes an ink layer 14 stacked on the releasing layer 12. This ink layer 14 incorporates at least one figure or one letter, thereby making the ink layer 14 a figure-based or a letter-based layer. The ink used in the ink layer 14 can be the sublimation ink, the hot melt ink, or the UV ink. An adhesive layer 15 is further provided on the ink layer 14. The adhesive layer 15 may comprise the hot melt adhesive, the UV curable adhesive, the photo curable adhesive, the electron curable adhesive, or the combination of the above adhesive.

Because the second roughened configuration 12B has a roughness Ra equal to or more than 0.5 μm, the releasing layer 12 should has a thickness of at least 1 μm. In this embodiment, the thickness varies from 1 μm to 10 μm.

Therefore, via the second roughened configuration 12B and the varying thickness, the releasing layer 12 enables the lights to shift in different directions. As a result, the composite optical film 1 of the first embodiment is capable of generating glossy gradient effects, partial glossy and partial foggy effect.

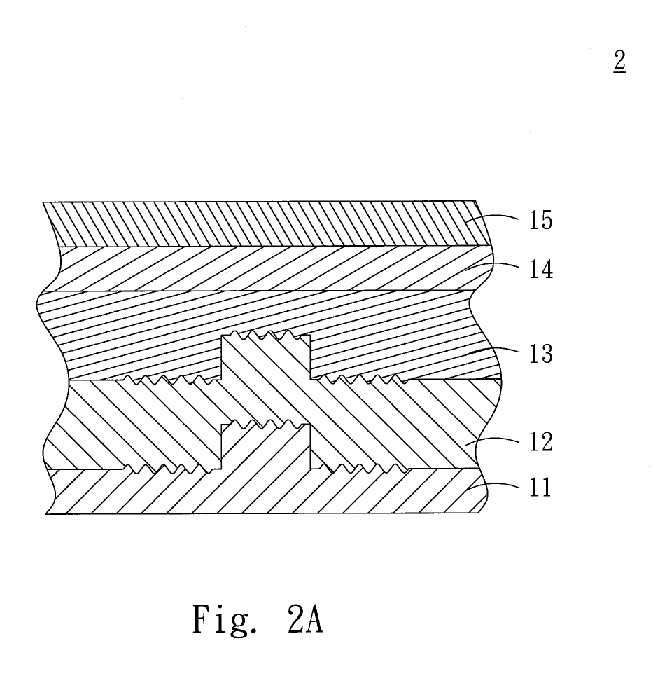

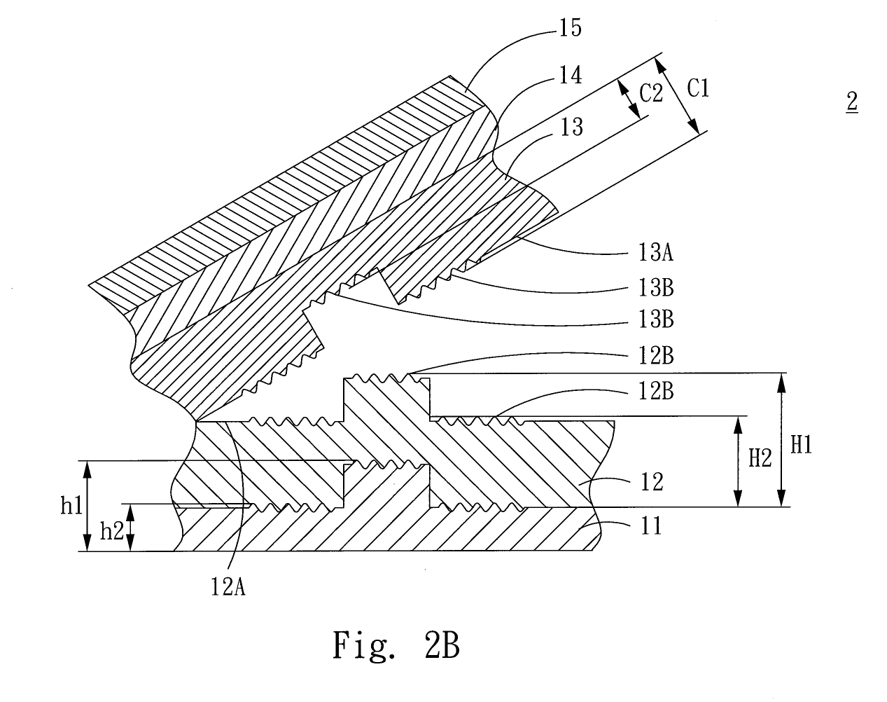

Please refer to FIG. 2A, which shows the second embodiment of the present invention. The composite optical film 2 further comprises a durable layer 13 interposed between the releasing layer 12 and the ink layer 14 to provide an anti-abrasion effect. The substrate 11, the releasing layer 12, the durable layer 13, the ink layer 14, and the adhesive layer 15 are stacked serially. The material from which this durable layer 13 is made can be radiant curable multifunctional acrylate, epoxide, vinyl ester resin, diallyl phthalate, or vinyl ether, or a combination of the aforementioned materials. Radiant curable multifunctional acrylate can be any one of the following kinds: epoxy acrylate, polyurethane acrylate, polyester acrylate, siloxane acrylate, or glycidyl acrylate. The substrate 11 and the releasing layer 12 of the second embodiment possess the same features as those described in the first embodiment.

Please refer to FIG. 2B, which also shows the second embodiment of the present invention. For describing the features more detailedly, the releasing layer 12 and the durable layer 13 are imaginarily stripped here. The durable layer 13 includes a third surface 13A which adheres to the second surface 12A of the releasing layer 12. The third surface 13A has a third roughened configuration 13B which is equivalent to the second roughened configuration 12B. The releasing layer 12 has a thicker first portion H1 and a thinner second portion H2. Because the durable layer 13 is stacked on the releasing layer 12, the durable layer 13 also possesses varying thickness where the third roughened configuration 13B being formed. Specifically, the durable layer 13 conformably has a thicker first portion C1 and a thinner second portion C2. In addition, the features of the ink layer 14 and the adhesive layer 15 are substantially the same as those described in the first embodiment.

What has to be noticed is that, because the durable layer 13 is interposed between the releasing layer 12 and the ink layer 14, the releasing layer 12 affects the roughness of the third roughened configuration 13B of the durable layer 13. The third roughened configuration 13B is corresponding and equivalent to the second roughened configuration 12B. Therefore, based on the varying thickness of the releasing layer 12 where the second roughened configuration 12B being formed, the durable layer 13 also possesses varying thickness where the third roughened configuration 13B being formed.

Because the second roughened configuration 12B has a roughness Ra equal to or more than 0.5 μm, accordingly, the third roughened configuration 13B has a roughness Ra equal to or more than 0.5 μm.

Therefore, via the third roughened configuration 13B and the varying thickness, the durable layer 13 enables the lights to shift in different directions. As a result, the composite optical film 2 of the second embodiment is capable of generating glossy gradient effects, partial glossy and partial foggy effect.

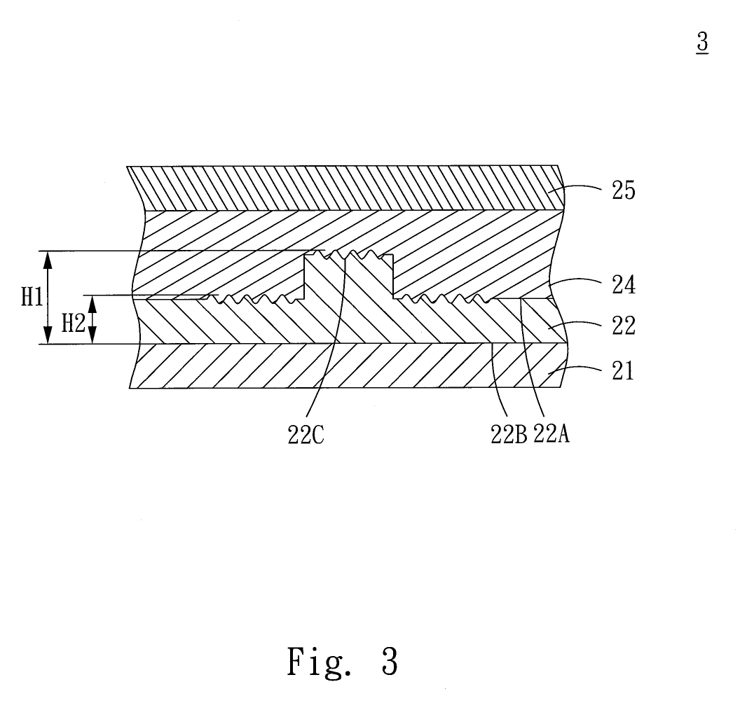

Please refer to FIG. 3, which shows the third embodiment of the present invention. A substrate 21, a releasing layer 22, an ink layer 24, and an adhesive layer 25 are stacked serially. The materials of the substrate 21 and the adhesive layer 25 are substantially the same as those described in the first embodiment. The releasing layer 22 comprises a first surface 22A and a second surface 22B opposing to the first surface 22A. The releasing layer 22 whose second surface 22B adheres to the substrate 21 has a thickness ranging from 1 μm to 10 μm and a first roughened configuration 22C.

When compared to the first embodiment shown in FIG. 1A and FIG. 1B, in this third embodiment, the first roughened configuration 22C is formed on the releasing layer 22 rather than on the substrate 21.

The third embodiment also employs an imprinting method to form the first roughened configuration 22C on the first surface 22A of the releasing layer 22. The imprinting method is substantially the same as those described in the first embodiment The releasing layer 22 has a thicker first portion H1 and a thinner second portion H2. Accordingly, the thickness of the releasing layer 22 has varying thickness where the first roughened configuration 22C being formed. The Ra value of the first roughened configuration 22C may be equal to or more than 0.5 μm. The releasing layer 22 has a thickness of at least 1 μm. In another embodiment, the thickness varies from 1 μm to 10 μm.

Accordingly, via the first roughened configuration 22C and the varying thickness, the releasing layer 22 enables the lights to shift in different directions. Therefore, the composite optical film 3 of the third embodiment is able to achieve the similar glossy gradient effects, partial glossy and partial foggy effect as those described in the first embodiment.

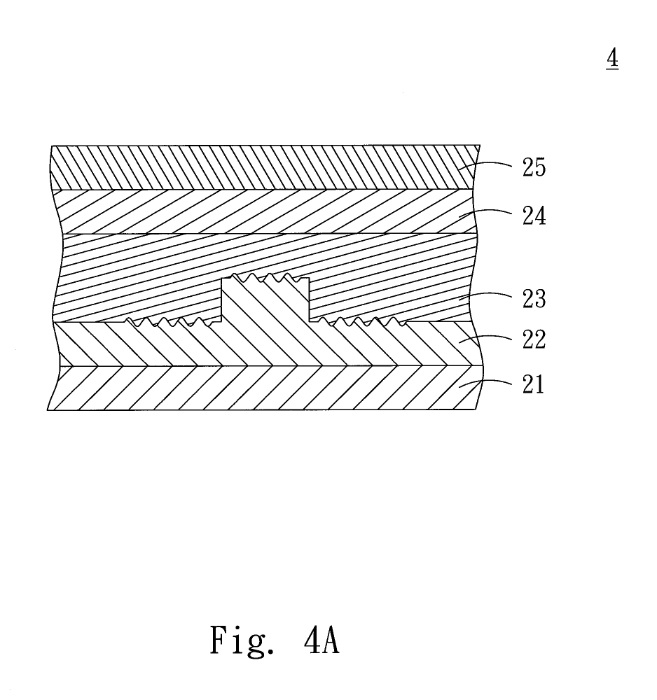

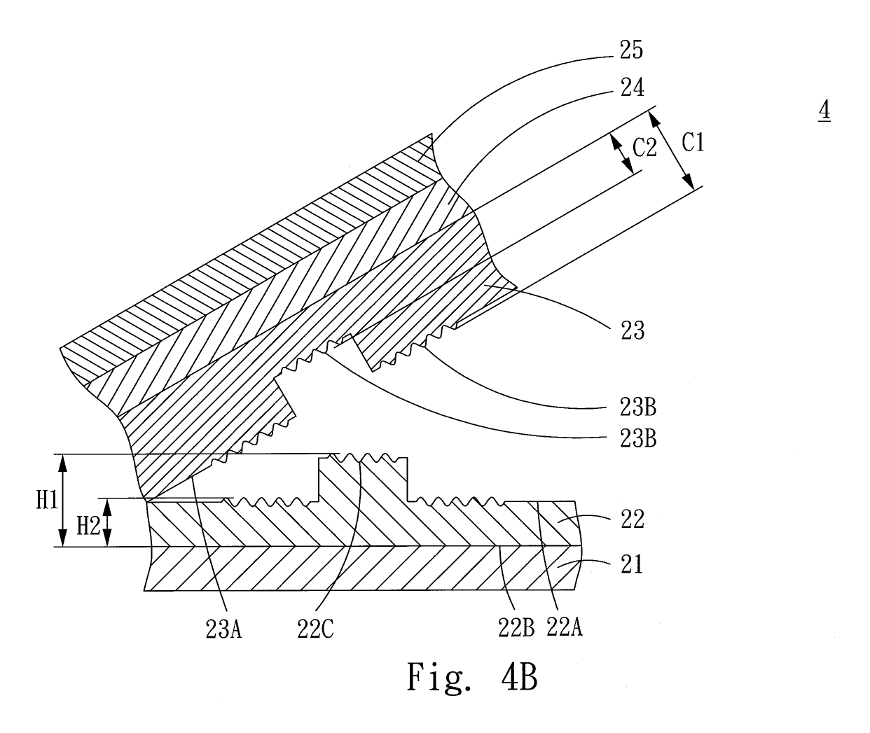

Please refer to FIG. 4A, which shows the fourth embodiment of the present invention. The composite optical film 4 in this embodiment further comprises a durable layer 23 interposed between the releasing layer 22 and the ink layer 24 to provide a low gloss effect. The substrate 21, the releasing layer 22, the durable layer 23, the ink layer 24, and the adhesive layer 25 are stacked serially. The features of the substrate 21, the releasing layer 22 and the adhesive layer 25 are substantially the same as those described in the third embodiment.

Please refer to FIG. 4B. The durable layer 23 is detailedly described here. The durable layer 23 includes a third surface 23A toward the releasing layer 22. The third surface 23A has a second roughened configuration 23B which is corresponding and complementary to the first roughened configuration 22C. Because the durable layer 23 is stacked and formed on the releasing layer 22, so the durable layer 23 also possesses varying thickness where the second roughened configuration 23B being formed. Specifically, because the releasing layer 22 has a thicker first portion H1 and a thinner second portion H2, so the durable layer 23 conformably has a thicker first portion C1 and a thinner second portion C2. In addition, the material of the durable layer 23 is substantially the same as those described in the second preferred embodiment.

It must be noted that, because the durable layer 23 is interposed between the releasing layer 22 and the ink layer 24, the releasing layer 22 affects the roughness of the second roughened configuration 23B of the durable layer 23. Accordingly, the composite optical film 4 of the fourth embodiment is able to generate the similar glossy gradient effects, partial glossy and partial foggy effect as those described in the second embodiment.

The composite optical film provided by this invention can be applied to a 3C product, a toy, or a cosmetics container to produce a decorated article. The characteristics of the decorated article comprising the composite optical film are described as below.

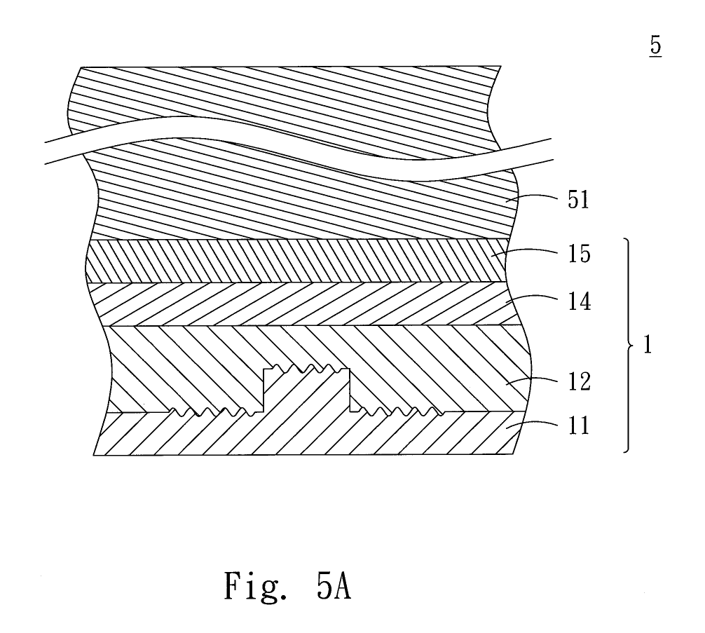

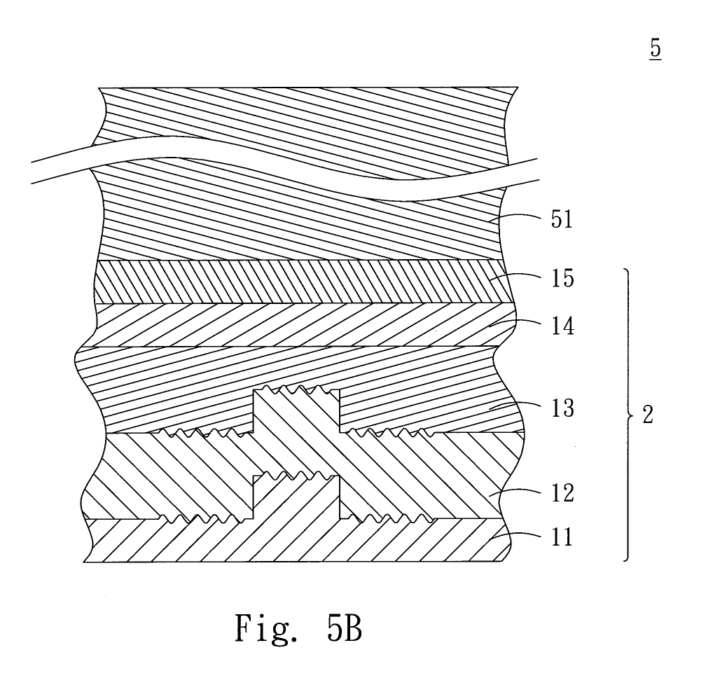

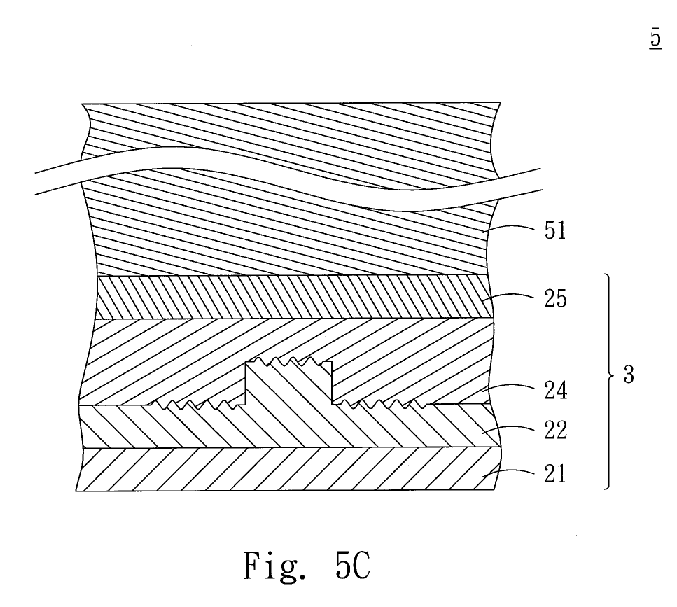

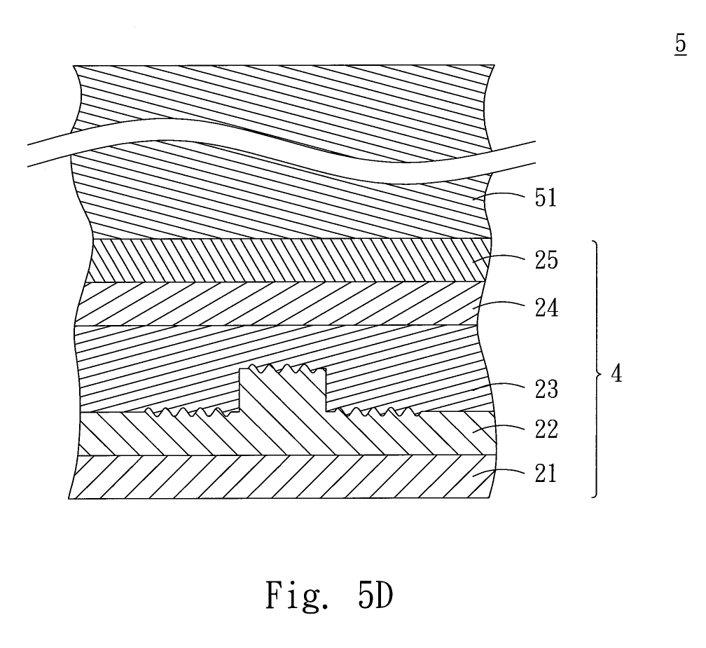

FIGS. 5A to 5D show the fifth embodiment of the present invention. A decorated article using a composite optical film is proposed. Please refer to FIG. 5A first. The decorated article 5 comprises a composite optical film 1 and a body 51 formed by a molding method on the adhesive layer 15 of the composite optical film 1. The molding method which forms the body 51 on the composite optical film 1 could be the injection molding, the hot-embossing, the compression molding, the blow molding, or the extrusion molding. The composite optical film used in this embodiment might be any one of the composite optical films as described in the first embodiment, the second embodiment, the third embodiment, and the fourth embodiment. Therefore, the decorated article 5 can has glossy gradient effects, partial glossy and partial foggy effect on its surface as those described in the first embodiment to the fourth embodiment. FIG. 5A shows the decorated article 5 which using a composite optical film 1 as described in first embodiment. FIG. 5B shows the decorated article 5 which using a composite optical film 2 as described in second embodiment. FIG. 5C shows the decorated article 5 which using a composite optical film 3 as described in third embodiment. FIG. 5D shows the decorated article which using a composite optical film 4 as described in fourth embodiment.

Although some particular embodiments of the invention have been described in detail for purposes of illustration, it will be understood by one of ordinary skill in the art that numerous variations will be possible to the disclosed embodiments without going outside the scope of the invention as disclosed in the claims.

What is claimed is:

1. A composite optical film, comprising a substrate, a releasing layer, an ink layer, and an adhesive layer, the composite optical film being characterized in that:
the substrate comprises a first surface with a first roughened configuration formed thereon and a varying thickness caused by the first roughened configuration, wherein the first roughened configuration is formed directly by an imprinting method, and has an average roughness Ra of at least 0.5 μm; and
the releasing layer comprises a second surface that adheres to the first surface, wherein the second surface comprises a second roughened configuration, the releasing layer comprises a varying thickness caused by the second roughened configuration, the second roughened configuration has a complimentary configuration corresponding to the first roughened configuration and has an average roughness Ra of at least 0.5 μm.

2. The composite optical film of claim 1, wherein the releasing layer has a thickness of at least 1 μm.

3. The composite optical film of claim 1, wherein the imprinting method is selected from the group consisting of planar imprinting, rolling imprinting, and stamping.

4. The composite optical film of claim 1, wherein the substrate is made from a material selected from the group consisting of polyethylene terephthalate, polyethylene naphthalate, glycol-polyethylene terephathalate, thermoplastic polyurethane, polyurethane, polypropylene polycarbonate, amorphous polyethylene terephthalate, polyvinyl chloride, cellulose triacetate, polymethylmethacrylate, styrene-methyl methacrylate copolymer, and cyclic olefin copolymer.

5. The composite optical film of claim 1, further comprising a durable layer interposed between the releasing layer and the ink layer, wherein the durable layer comprises a third surface which adheres to the releasing layer, the third surface has a third roughened configuration which has an equivalent configuration as the second roughened configuration.

6. The composite optical film of claim 5, wherein the durable layer is made from a material selected from the group consisting of radiant-curable multifunctional acrylate, epoxide, vinyl ester resin, diallyl phthalate, and vinyl ether.

7. The composite optical film of claim 6, wherein the radiant-curable multifunctional acrylate is selected from the group consisting of epoxy-acrylate, polyurethane acrylate, polyester acrylate, siloxane acrylate, and glycidyl acrylate.

8. The composite optical film of claim 1, wherein the ink layer comprises at least one figure or at least one letter.

9. The composite optical film of claim 1, wherein the ink layer comprises an ink selected from the group consisting of sublimation ink, hot-melt ink, and UV ink.

10. A composite optical film, comprising a substrate, a releasing layer, an ink layer, and an adhesive layer, the composite optical film being characterized in that:
the releasing layer comprises a varying thickness, a first surface and a second surface opposing to the first surface, wherein the second surface adheres to the substrate, the first surface comprises a first roughened configuration which is formed directly by an imprinting method, and the first roughened configuration has an average roughness Ra of at least 0.5 μm.

11. The composite optical film of claim 10, wherein the imprinting method is selected from the group consisting of planar imprinting, rolling imprinting, and stamping.

12. The composite optical film of claim 10, wherein the releasing layer has a thickness of at least 1 μm.

13. The composite optical film of claim 10, wherein the substrate is made from a material selected from the group consisting of polyethylene terephthalate, polyethylene naphthalate, glycol-polyethylene terephathalate, thermoplastic polyurethane, polyurethane, polyethylene, polycarbonate, amorphous polyethylene terephthalate, polyvinyl chloride, cellulose triacetate, polymethylmethacrylate, styrene-methyl methacrylate copolymer, and cyclic olefin copolymer.

14. The composite optical film of claim 10, further comprising a durable layer interposed between the releasing layer and the ink layer, wherein the durable layer comprises a third surface toward the releasing layer, the third surface has a second roughened configuration which has a complimentary configuration corresponding to the first roughened configuration.

15. The composite optical film of claim 10, wherein the ink layer comprises at least one figure or at least one letter.

16. The composite optical film of claim 10, wherein the ink layer comprises an ink selected from the group consisting of sublimation ink, hot melt ink, and UV ink.

17. A decorated article, comprising a composite optical film and a body formed on the composite optical film, the composite optical film comprising a substrate, a releasing layer, an ink layer, and an adhesive layer, wherein:
the releasing layer comprises a varying thickness, a first surface and a second surface opposing to the first surface, wherein the second surface adheres to the substrate, the first surface comprises a first roughened configuration which is formed directly by an imprinting method, and the first roughened configuration has an average roughness Ra of at least 0.5 μm.

18. The decorated article of claim 17, wherein the releasing layer has a thickness of at least 1 μm.

19. The decorated article of claim 17, wherein the body is formed on the composite optical film by a method selected from the group consisting of injection molding, hot-embossing, compression molding, blow molding, and extrusion molding.

20. The decorated article of claim 17, further comprising a durable layer interposed between the releasing layer and the ink layer, wherein the durable layer comprises a third surface toward the releasing layer, the third surface has a second roughened configuration which has the equivalent configuration as the first roughened configuration.
